(19) United States
(12) Patent Application Publication
(10) Pub. No.: US 2008/0193626 A1
(43) Pub. Date: Aug. 14, 2008

(54) Process For Making Tea

(76) Inventors: Timothy Graham Jones, Bedfordshire (GB); Navin Kumar Sharma, Hyderabad (IN)

Correspondence Address: UNILEVER PATENT GROUP, 800 SYLVAN AVENUE, AG West S. Wing, ENGLEWOOD CLIFFS, NJ, 07632-3100, US

(21) Appl. No.: 11/661,945

(22) PCT Filed: Aug. 4, 2005
(86) PCT No.: PCT/EP2005/008498

§ 371 Date: Feb. 7, 2008

(30) Foreign Application Priority Data
Sep. 4, 2004 (GB) 0419691.1

(51) Int. Cl. A23F 3/00

(52) U.S. Cl. 426/597

(57) ABSTRACT

A process for manufacturing amino acid-rich tea or tea extract is provided. The process uses tea starting material comprising at least 50 wt % of tea plant material harvested within 3 hours before and after sunrise and then processing the tea in a conventional tea process and packaging to provide a vendible tea product comprising at least 50 wt % of tea plant material harvested within 3 hours before and after sunrise. The observation that tea has more amino acids near to sunrise gives rise to a tea which is naturally high in amino acids.

The present invention relates to a process for making amino acid-rich tea or tea extracts.

### BACKGROUND AND PRIOR ART

Tea is generally prepared as green leaf tea or black leaf tea. The method of preparing such teas is well known to those skilled in the art. Generally, to prepare black leaf tea, fresh green leaves of the plant Camellia sinensis are withered (subjected to mild drying), comminuted, fermented (in which process enzymes in the leaf tea use atmospheric oxygen to oxidise various substrates to produce brown-coloured products) and then fired (to dry the tea leaves). Green leaf tea is not exposed to the fermentation process. Partial fermentation may be used to produce intermediate-type teas known as “oolong” tea. Conventionally, a portion of the upper most part of the tea plant is harvested, which usually involves plucking a number of leaves (normally two to up to seven) together with a bud.

Today tea based beverages can be prepared by methods other than infusing leaves in hot water and served in ways other than poured from tea pots. For example they can be made with concentrates or powders that are mixed with hot water in vending machines or used to prepare ready to drink teas in cans and bottles. Consumers also demand more from tea such as accelerated infusion, more colour, more aroma.

In particular the modern consumer is interested in naturally healthy beverages which form part of a modern healthy lifestyle. As a beverage, tea fits well with this attitude in view of its natural content of inter alia flavonoids, catechins and amino acids. There is therefore a need in the art to provide a method for the concentration of these naturally occurring healthy ingredients whilst maintaining the healthy nature of tea without adding synthetic compounds.

The present inventors have surprisingly discovered that material of the tea plant camellia sinensis contains a higher concentration of amino acids when harvested in the early hours of the morning. It is believed that amino acids are generated through the night and are used up during the day.

Thus, the present invention provides a process for manufacturing amino acid-rich tea or tea extract using tea starting material comprising at least 50 wt % of tea plant material harvested within 3 hours before and after sunrise and then processing the tea in a conventional tea process and packaging to provide a vendible tea product comprising at least 50 wt % of tea plant material harvested within 3 hours before and after sunrise.

In a second aspect, the present invention provides a packaged tea product which comprises at least 50 wt % of tea plant material harvested within 3 hours before and after sunrise.

### DETAILED DESCRIPTION OF THE INVENTION

The process of the present invention comprises the steps of harvesting a tea source material at or near to sunrise and then processing and packaging the tea. The starting material and the resultant packaged product comprise at least 50 wt % of tea plant material harvested within 3 hours before and after sunrise where the tea is harvested.

The leaf tea is preferably processed in a convention black tea manufacturing process, comprising the steps of withering, maceration, fermentation, firing.

“Tea” for the purposes of the present invention means leaf material from Camellia sinensis var. sinensis, or Camellia sinensis var. assamica. “Tea” is also intended to include the product of blending two or more of any of these teas.

### Early Morning Tea

Tea is conventionally plucked gradually throughout the day and no particular preference is placed on tea plucked in the morning, afternoon or evening. Therefore, conventional processes use tea which is a blend of tea plucked throughout the working day as a starting material. Sometimes tea plucked early in the morning is collected as a batch to be processed. In this case, although the starting material may be early harvested tea, the processed tea is blended with tea harvested later in the day, so no packaged vendible product based on early harvested tea is ever produced.

For the purposes of the present invention, at least 50 wt % of the starting material and/or the packaged product is early harvested tea which is tea plant material harvested within 3 hours before and after sunrise. In this way, the concentration of amino acids is naturally increased due to our observation that their concentration in the tea plant is higher near to sunrise.

Preferably the starting material and/or the packaged product tea comprises at least 60 wt %, more preferably at least 70 wt % of early harvested tea. The starting material and/or the packaged product may comprise as much as 80 wt % early harvested tea, as much as 90 wt % early harvested tea or may even be 100 wt % early harvested tea.

Early harvested tea is tea plant material harvested within 3 hours of sunrise at the locale of the tea plant. Preferably early harvested tea is tea plant material harvested within 2 hours of sunrise, or even within 1 and a half hours of sunrise, or even within 1 hour of sunrise.

### Processing the Tea Material

In the process of the present invention, the early morning tea material is preferably processed as though it were normal leaf tea. In this way, the tea material is subjected to at least on of the following black tea processing unit operations: withering, maceration, grinding, steaming, fermentation, firing and infusing. Thus the tea may be black, green, or oolong tea.

Preferably the tea material is subjected to withering, a maceration step followed by fermentation and firing to arrest fermentation. This is a conventional black tea process.

Once produced, the tea is further processed to prepare the tea for sale as a vendible product. The vendible product remains an early harvested tea, even though this allows for the possibility of some dilution after or during processing provided the vendible product remains at least 50 wt % of tea plant material harvested within 3 hours before and after sunrise.

### Maceration

The leaf tea may be macerated. One can macerate tea in many ways but broadly speaking there are two main mechanized methods for doing this.

The first, called “orthodox manufacture”, involves rolling withered tea leaves as part of a standardised procedure including fermenting and drying steps. So called “orthodox tea” is typically characterised by large leaf portions that are aesthetically pleasing to many but produce lighter liquors due to less extensive fermentation.

The second method is the most popular of a number of non-orthodox methods that involves using a machine resembling a mangle that cuts, tears and curls tea leaves. The original machine was invented by W. McKercher in 1930 and is commonly referred to a CTC (cut-tear-curl) machine. The finely cut product is known generically as “CTC tea” and is characterised by a fast infusion rate and strong colour.

Both orthodox and CTC machines are often used in conjunction with a Rotorvane machine that minces withered tea leaves. These methods and their history and role in tea manufacture are described in “Tea: cultivation to consumption” edited by K. C. Willson and M. N. Clifford, Chapman & Hall, 1992.

Generally speaking consumer preference for either orthodox or CTC tea is a matter of national or regional culture. In some countries the visual appearance and texture of leaf tea are both important indicators of quality, larger leaf particles being associated with higher quality. In Western markets tea is increasingly purchased in filter paper bags and the colour of the infused product is more important.

### Fermentation

The next optional step is commonly called fermentation but that is a misnomer. “Fermentation” is commonly used in the context of brewing alcohol to describe the action of exogenous enzymes. However in the tea world it is used to refer to the oxidative process that tea undergoes when certain endogenous enzymes and substrates are brought together by mechanical disruption of the cells by tearing or cutting the leaves. Tea and other plant material can be oxidised by the action of exogenous enzymes such as oxidases, laccases and peroxidases so for present purposes the term “fermentation” will describe enzymic oxidation regardless of the source of the enzymes responsible. The essential fermentation step is believed to provide the desirable black tea colour and flavour characteristics.

### Firing

In order to terminate fermentation, the tea leaves must be subjected to a high temperature for a short period of time. This stage is called ‘firing’ and is well-known in the art.

### Infusion of Tea

In a preferred process, the tea material is infused in water in order to extract the tea solids and amino acids. Preferably the tea material is at least fermented before infusion occurs.

Infusions of the tea material may be prepared using either a simple extraction process or an enzymatically assisted extraction process.

The tea material is preferably combined with water in an extractor at the desired temperature to obtain a tea infusion slurry containing extracted tea material and solid tea material. After infusion the solid tea material is separated from the tea infusion for example by filtration and/or centrifugation.

Enzymatically assisted extraction, if used, requires the addition of enzymes to the extractor in the form of an enzyme cocktail or the enzymes can be fed to the extractor individually. For example, an enzyme cocktail including selected cell wall lysis enzymes such as carbohydrases including cellulase and mascerase, for example, Viscozyme L™ obtainable from NOVO Industri A/S Denmark may be used. The tea slurry containing the enzymes is then hot extracted to complete the infusion process and the solid tea material is separated from the tea extract as above. The tea extract is then preferably pasteurized to deactivate the enzymes.

The resulting tea infusion is then optionally concentrated and then cooled and polished by centrifugation or other clarification methods such as filtration and the like. After polishing, the extract is then concentrated for example by vacuum concentration or by falling film type evaporation and dried for example by spray drying to give tea powder for use in the present invention.

The resulting finished infusion may then be concentrated and/or dried to produce an amino-acid rich tea powder.

### Packaging

Once the plucked tea has been processed, the tea is then packed in a form in which it may be sold. This may for example be large sacks for sale at an auction, or it may be a subsequent smaller packaging appropriate for sale to a consumer.

The final packaged tea may possibly contain tea which was added from a different source to the early morning tea starting material. However in this case, the packed tea product must still comprise at least 50 wt % of tea plant material harvested within 3 hours before and after sunrise.

Preferably the packaging is marked with an indication that the tea product is plucked early in the morning. Additionally, the packaging is preferably marked with an indication that the tea product is high in amino acids, preferably marked as naturally high in amino acids. Preferably, the packaging is marked with an indication that the tea product is high in theanine, preferably marked as being naturally high in theanine.

### EXAMPLES

Tea was plucked as ‘three leaves and a bud’ from six different tea plantations around the world. The tea was plucked at 7 am, 12 noon, 5 pm and 10 pm. In each location sunrise was within 2 hours of 7 am. The plucked tea was then analysed for its theanine content, a major component of the available amino acids. The following results were obtained.

Time of plucking

| Location | 7 am | 12 noon | 5 pm | 10 pm |
|---|---|---|---|---|
| 1 | 2.2 | 1.45 | 0.8 | 0.7 |
| 2 | 1.78 | 0.85 | 0.45 | 0.45 |
| 3 | 0.9 | 0.25 | 0.2 | 0.25 |
| 4 | 3.85 | 2.2 | 2.1 | 1.65 |
| 5 | 2.40 | 1.40 | 1.30 | 1.55 |
| 6 | 1.05 | 0.6 | 0.6 | 0.50 |

It can clearly be seen that the level of theanine is much greater in the morning than later in the day.

The tea which was plucked at 7 am was subsequently processed in a conventional black tea process of withering, maceration, fermentation and firing to produce a black tea naturally high in theanine. The tea was packaged into 50 kg sacks and marked as being tea which is plucked early in the morning and being naturally high in theanine.

1. A process for manufacturing amino acid-rich tea or tea extract using tea starting material comprising at least 50 wt % of tea plant material harvested within 3 hours before and after sunrise and then processing the tea in a conventional tea process and packaging to provide a vendible tea product comprising at least 50 wt % of tea plant material harvested within 3 hours before and after sunrise.

2. A process according to claim 1, wherein the starting material and/or the packaged product comprises at least 60 wt % of tea plant material harvested within 3 hours before and after sunrise.

3. A process according to claim 1 wherein the starting material and/or the packaged product comprises at least 70 wt % of tea plant material harvested within 3 hours before and after sunrise.

4. A process according to claim 1, wherein the processing comprises at least one step selected from withering, maceration, steaming, grinding, fermentation, firing, sorting, infusing.

5. A process according to claim 1, wherein the tea is infused in water to produce an aqueous infusion of tea solids.

6. A process according to claim 5, wherein the infusion is concentrated and/or dried to produce a amino-acid rich tea concentrate comprising from 100 to 50 wt % tea solids.

7. A process according to claim 1, wherein the packaging is marked with an indication that the tea product is plucked early in the morning.

8. A process according to claim 1, wherein the packaging is marked with an indication that the tea product is high in amino acids.

9. A process according to claim 8, wherein the packaging is marked with an indication that the tea product is high in theanine.

10. A packaged tea product which comprises at least 50 wt % of tea plant material harvested within 3 hours before and after sunrise.
